(19) United States
(12) Patent Application Publication
(10) Pub. No.: US 2014/0095415 A1
(43) Pub. Date: Apr. 3, 2014

(54) APPARATUS AND METHOD FOR FORECASTING ENERGY CONSUMPTION

(71) Applicant: Electronics and Telecommunications Research Institute, Daejeon (KR)

(72) Inventors: Jae Hak YU, Daejeon (KR); Byung Bog LEE, Daejeon (KR); Yoon Sik YOO, Daejeon (KR); Hyochan BANG, Daejeon (KR)

(21) Appl. No.: 13/916,309

(22) Filed: Jun. 12, 2013

(30) Foreign Application Priority Data
Sep. 28, 2012 (KR) 10-2012-0108638

(51) Int. Cl. G06N 99/00

(52) U.S. Cl. CPC G06N 99/005
USPC 706/12

(57) ABSTRACT

An apparatus for forecasting energy consumption includes a load data collection unit to collect low level data related to energy load data. The apparatus includes a filtering/attribute selection unit to eliminate duplicated attributes from attributes of low level data to produce an optimal attribute set. The apparatus includes a training unit produces a multi-class in which a plurality of single classes is hierarchically coupled in at least two levels and creates training data used for forecasting the energy consumption based on the produced multi-class. The apparatus includes a forecasting unit calculates the energy consumption to be forecasted on a basis of the real-time low level data, the multi-class and the training data. Therefore, it is possible to contribute to the progressive expansion and update of a cooling load forecasting system.

### RELATED APPLICATIONS

This application claims the benefit of Korean Patent Application No. 10-2012-0108638, filed on Sep. 28, 2012 which is hereby incorporated by reference as if fully set forth herein.

### FIELD OF THE INVENTION

The present invention relates to an energy consumption forecast, and more particularly, relates to an apparatus and method for forecasting energy consumption based on a multi-class which is created with a plurality of single classes coupled in a hierarchal coupling structure of two or more phases.

### BACKGROUND OF THE INVENTION

For the management of power use in buildings, an efficient use of loads act as a requisite factor and it is crucial to forecast the loads in a future. In particular, as the use of air conditioning equipment associated with heating and cooling is given a sizeable deal of weight, reducing the heating and cooling energy in the buildings is a nationally significant challenge. To meet the challenge, environment-friendly and energy-saving cooling systems such as ice storage, water heat storage, terrestrial heat and district cooling, in addition to the existing turbo, and absorption refrigerator has been applied and spread to the cooling of the buildings. The cooling system is composed in the form of a combination of several devices according to the geographical environment and energy demand pattern of the buildings and has various kinds of operational strategies. Accordingly, forecasting the cooling consumption is one of critical element technologies in order simultaneously to achieve a pleasant cooling condition and an energy-saving.

In surveying conventional techniques for the prediction of cooling consumption, there has been tried a variety of methods inclusive of time series, regression analysis, neural network and fuzzy theory. These methods mainly use past data on the cooling consumption. In more detail, the elements of the consumption forecast includes user category, elements of weather condition such as temperature, humidity and wind speed, consumption pattern that was used recently, the temporal characteristics of the day, weekly or seasonal load use, event for a specific exercise, load distribution such as the moderate use of a cooling load and the rapid use of an electricity use, and demand-side management plan, which makes a modeling for consumption prediction different. In order to design a system for managing a power usage by using a cooling consumption that is predicted, there needs a model identical to the pattern that is actually used, which requires to consider more elements.

### SUMMARY OF THE INVENTION

In view of the above, the present invention provides an apparatus and method for forecasting energy consumption based on a plurality of single classes in a multi-class which is created by using a single class SVM (Support Vector Machine) based hierarchical structure.

In accordance with an exemplary embodiment of the present invention, there is provided an apparatus for forecasting energy consumption, which includes: a load data collection unit configured to collect low level data from a device that generates energy load data; a filtering and attribute selection unit configured to eliminate attributes that are duplicated or used below a prefixed average from attributes of the collected low level data to produce an optimal attribute set; a training unit configured to produce a multi-class in which a plurality of single classes is hierarchically coupled in at least two levels and create training data used for forecasting the energy consumption based on the produced multi-class, wherein each single class includes its optimal attribute set; and a forecasting unit configured to receive the low level data in real time from the load data collection unit and calculate the energy consumption to be forecasted on a basis of the received real-time low level data, the multi-class and the training data.

In the exemplary embodiment, the filtering and attribute selection unit is configured to calculate a conditional probability using entropies of the attributes, Pearson's correlation coefficients between the attributes and target classes including the attributes and the best search method to produce the optimal attribute set.

In the exemplary embodiment, the filtering and attribute selection unit is configured to: calculate an entropy of an arbitrary attribute contained in the low level data; calculate a conditional probability between the arbitrary attribute and each of remaining arbitrary attributes; calculate information gain for each of the arbitrary attribute and the remaining attributes; calculate conditional probability correlation using the arbitrary attribute and each of remaining arbitrary attributes, the distribution and Pearson's correlation coefficient between the arbitrary attribute and each of remaining arbitrary attributes and target classes including the arbitrary attribute, based on the information gain; form a plurality of subsets based on the conditional probability correlation; and calculate merit functions with respect to the plurality of subsets to select a subset whose merit function has the largest value as the optimal attribute set.

In the exemplary embodiment, the training unit is configured to produce the multi-class on a basis of an SVDD (Support Vector Data Description) for generating each of the single classes.

In the exemplary embodiment, the training unit is configured to produce the multi-class having a determination boundary surface to be independent.

In the exemplary embodiment, the apparatus further includes a filtering unit configured to filter the real-time low level data using the optimal attribute set, and the forecasting unit is configured to forecast the energy consumption based on the filtered data and the training data.

In accordance with another aspect of the exemplary embodiment of the present invention, there is provided a method for forecasting energy consumption, which includes: collecting low level data from a device that generates energy load data; eliminating attributes that are duplicated or used below a prefixed average from the attributes of the collected low level data to produce an optimal attribute set; producing a plurality of single classes, each single class including its optimal attribute set; producing a multi-class in which the single classes are hierarchically coupled in at least two levels; and creating training data to forecast the energy consumption based on the produced multi-class.

In the exemplary embodiment, producing the optimal attribute set includes: calculating an entropy of an arbitrary attribute contained in the low level data; calculating a conditional probability between the arbitrary attribute and each of remaining attributes; calculating information gain for each of the arbitrary attribute and the remaining attributes; calculating conditional probability correlation using the arbitrary attribute and each of remaining arbitrary attributes, the distribution and Pearson's correlation coefficient between the arbitrary attribute and each of remaining arbitrary attributes and target classes including the arbitrary attribute, based on the information gain; forming a plurality of subsets based on the conditional probability correlation; and calculating merit functions with respect to the plurality of subsets to select a subset whose merit function has the largest value as the optimal attribute set.

In the exemplary embodiment, producing a plurality of single classes includes: producing a determination boundary surface of each single class so that the plurality of the single classes is independent to one another; calculating a sphere size including the optimal attribute set; and producing the plurality of single classes based on the calculate sphere size and the determination border surface.

In the exemplary embodiment, collecting low level data includes: filtering the real-time low level data using the optimal attribute set; and forecasting the energy consumption based on the filtered data and the training data. According to the exemplary embodiment, unlike to provide only the error range between an actual cooling load and a predicted cooling load based on a conventional regression analysis which is a typical statistical method and is actively utilized in the cooling load forecast, the exemplary embodiment of the present invention has a merit to forecast the cooling load using a structure in which the single classes are hierarchically coupled in two or more levels, thereby enabling to forecast the class-wise cooling load forecast.

Further, the exemplary embodiment has a merit in that the levels such as month, week, day, time-of-day, minute time, etc. are hierarchically defined for the management of the cooling load, thereby enabling the analysis and prediction in accordance with a level of abstraction.

Moreover, the exemplary embodiment may contribute to the progressive expansion and update of a cooling load forecasting system because even though a new level or a new class in the new level is added, the cooling load forecaster 100 in accordance with the embodiment trains only class that has been newly added without having to relearn the entire system again.

### BRIEF DESCRIPTION OF THE DRAWINGS

The above and other objects and features of the present invention will become apparent from the following description of the embodiments given in conjunction with the accompanying drawings, in which:

FIG. 1 is a block diagram of a system for forecasting a cooling load in real time in accordance with an exemplary embodiment of the present invention;

FIG. 2 is a diagram illustrating a concept of the delivery of information to a cooling load forecasting module in accordance with an exemplary embodiment of the present invention; and

FIG. 3 illustrates an exemplary diagram of a multi-class in which SVDDs of single classes are coupled hierarchically in two levels.

### DETAILED DESCRIPTION OF THE EMBODIMENTS

The advantages and features of exemplary embodiments of the present invention and methods of accomplishing them will be clearly understood from the following description of the embodiments taken in conjunction with the accompanying drawings. However, the present invention is not limited to those embodiments and may be implemented in various forms. It should be noted that the embodiments are provided to make a full disclosure and also to allow those skilled in the art to know the full scope of the present invention. Therefore, the present invention will be defined only by the scope of the appended claims.

In the following description, well-known functions or constitutions will not be described in detail if they would unnecessarily obscure the embodiments of the invention. Further, the terminologies to be described below are defined in consideration of functions in the invention and may vary depending on a user's or operator's intention or practice. Accordingly, the definition may be made on a basis of the content throughout the specification.

Hereinafter, an apparatus and method capable of forecasting energy consumption based on a multi-class will be described in detail with reference to the accompanying drawings. Among other things, the exemplary embodiment of the present invention will be explained about an apparatus and method for forecasting a use of a cooling load from among energy consumption.

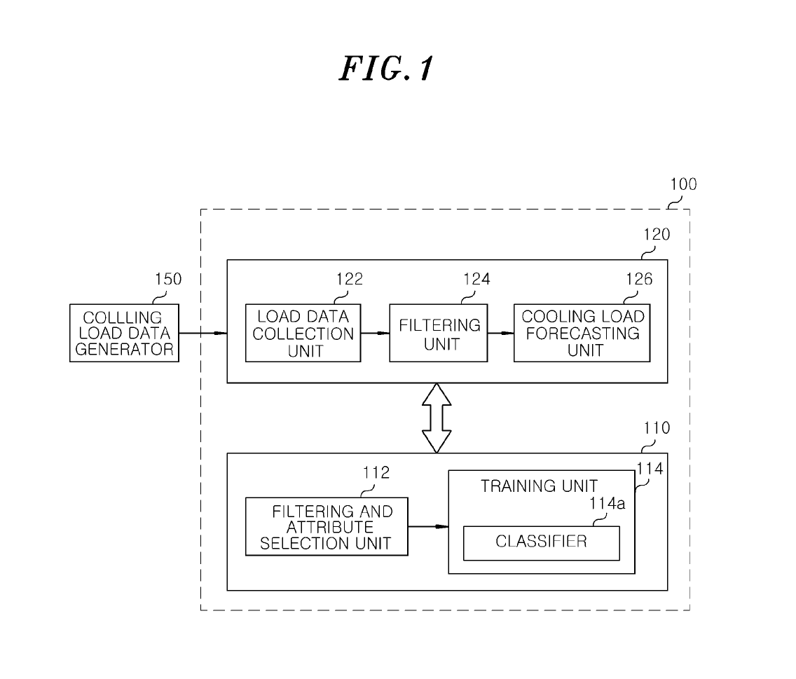

FIG. 1 is a block diagram of an apparatus for forecasting a use of a cooling load in real time in accordance with an exemplary embodiment of the present invention. The apparatus for forecasting the use of the cooling load includes a cooling load forecaster 100 and a cooling load data generator 150. The cooling load data generator 150 generates low level data related to a cooling load and provides the generated cooling load to the cooling load forecaster 100.

As illustrated in FIG. 1, the cooling load forecaster 100 generally includes a learning processing module 110 and a cooling load forecasting module 120. Moreover, the learning processing module 110 includes a filtering and attribute selection unit 112, a multi-class SVDD (Support Vector Data Description) training unit 114, and the cooling load forecasting module 120 includes a load data collection unit 122, a filtering unit 124 and a cooling load forecasting unit 126.

The load data collection unit 122 collects data related to a cooling load from among the low level data for the storage thereof and may be implemented with a storage device such as a hard-disk drive.

The load data collection unit 122 also delivers the low level data to the filtering/attribute selection unit 112 and the cooling load forecasting unit 126.

The filtering/attribute selection unit 112 selects optimal attributes to be used for forecasting the cooling load by removing data in advance that has a duplicated property or hinders a forecast performance from among the low level data necessary for forecasting and analyzing the cooling load. In this case, the data that hinders the forecast performance may be defined in advance or may be a data that has not been frequently used below an average.

In other words, the filtering/attribute selection unit 112 eliminates useless data to forecast the cooling load to achieve the reduction of data in level, which results in shortening the performance time for forecasting and classifying the cooling load as well as improving the forecasting performance. This filtering/attribute selection unit 112 is in charge of searching an attribute subset ‘d’ in which attributes that are hardly used or have a duplicated property have been eliminated from an initial attribute set ‘D’, i.e., the low level data.

An exemplary embodiment of the present invention employs a method for selecting attribute subsets, but not limited to, “Correlation-based feature selection for machine learning, PhD Diss. Department of Computer Science, Waikato University, Hamilton, NZ, 1998”, of which performance is verified among the other methods.

The method employed in the embodiment of the present invention is a method for searching an attribute set having a minimum number of attributes, i.e., an optimal attribute set capable of representing a probability distribution of overall attributes as close as possible by calculating a conditional probability using the best first search method, an entropy of an attribute or feature Y, and the Pearson's correlation coefficient between a target class having the attribute Y and the remaining attributes. First, in order to obtain information gain of the attributes included in the low level data, the entropy of the arbitrary attribute Y is calculated by Equation 1 as follows.

$$H ( Y ) = - {\sum }_{y ∈ Y} p ( y ) {log}_{2} ( p ( y ) ) \qquad Eq . 1$$

If the observed values of Y in the training data are partitioned according to the values of a second feature X, and the entropy Y with respect to the partitions induced by X is less than the entropy of Y prior to partitioning, then there is a relationship between features Y and X. Equation 2 gives the entropy of Y after observing X.

$$H ( Y \vert X ) = - {\sum }_{x ∈ X} p ( x ) {\sum }_{y ∈ Y} p ( y \vert x ) {log}_{2} ( p ( y \vert x ) ) \qquad Eq . 2$$

The amount by which the entropy of Y decreases reflects additional information about Y provided by X and is called the information gain. The information gain for each attribute can be defined by Equation 3 using Equations 1 and 2.

Gain=H(Y)+H(X)−H(X,Y) Eq. 3

Based on the information gain obtained from Equation 3, conditional probability correlation is calculated using two arbitrary attributes X and Y, the distribution between the arbitrary attribute X and a target class having the arbitrary attribute Y, and Pearson's correlation coefficient on a basis of the symmetrical uncertainty as illustrated in Equation 4. Furthermore, the correlations in Equation 4 should be normalized to ensure they are comparable and have the same affect. In this case, if the attribute Y has a higher distribution over the attribute X and has a correlation with respect to the attribute X, the attribute X is included in a subset that can effectively represent all attributes, but the attribute Y is not included in the subset. Similarly, the correlation and distribution and between target classes including the arbitrary attribute Y and the remaining attributes are calculated to form the subsets.

$$Symmetrical uncertainty coefficient = 2.0 \times [ \frac{Gain}{H ( Y ) + H ( X )} ] \qquad Eq . 4$$

In order to evaluate how each subset Fₛ⊂F effectively express overall attributes or features therein, a merit function is used as in Equation 5.

$$Merit ( {F}_{s} ) = \frac{k \overline{{r}_{cf}}}{\sqrt{k + k ( k - 1 ) \overline{{r}_{ff}}}} \qquad Eq . 5$$

Where Fₛ is the merit function of a feature subset S containing k features, r̅_̅{̅c̅f̅}̅ is the mean feature-class correlation, and r̅_̅{̅f̅f̅}̅ is the average feature-feature inter-correlation.

Further, a subset whose merit function has the largest value in Equation 5 is determined as the subset that can optimally express the attributes, and the determined subset is determined as an optimal attribute set.

The optimal attribute set determined through the above procedure is provided to the filtering unit 124, the cooling load forecasting unit 126 and the training unit 114.

The training unit 114 produces a multi-class in which a plurality of single classes is hierarchically coupled in two or more levels wherein each single class has its optimal attribute set and creates a training data for forecasting the cooling load based on the multi-class.

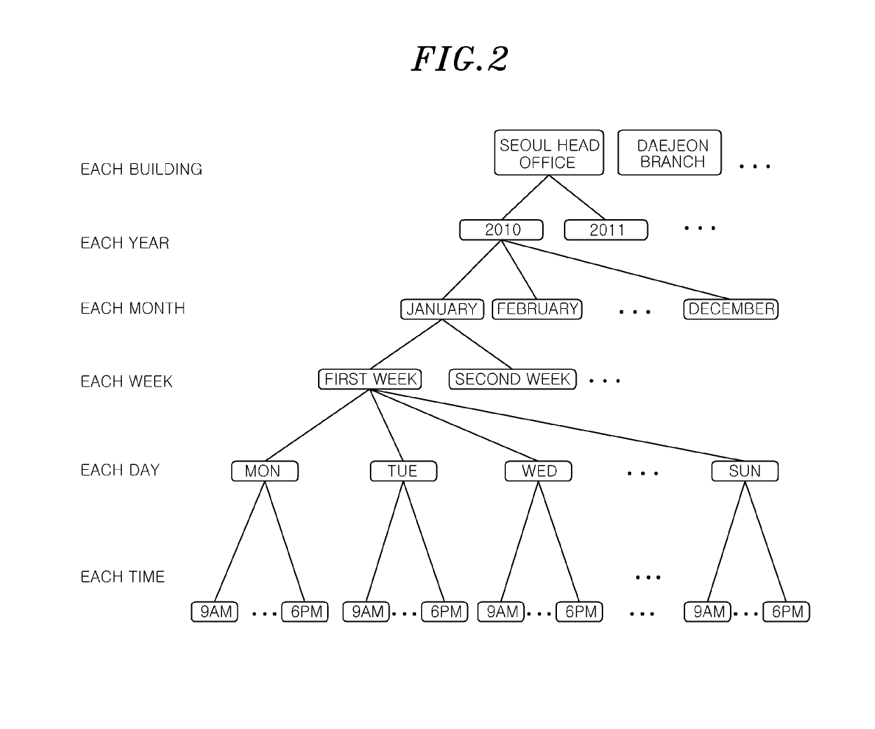

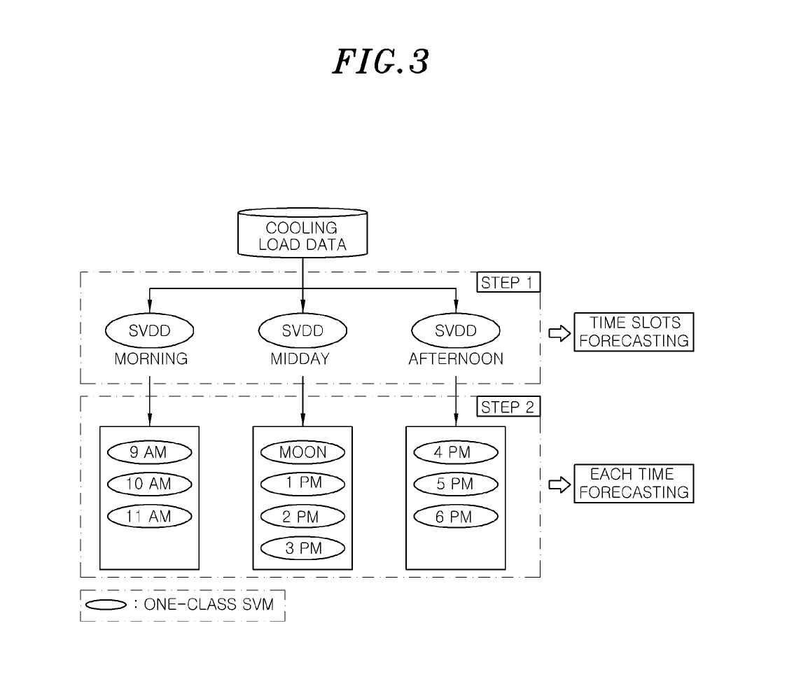

FIG. 2 is a conceptual diagram illustrating the delivery of information to the cooling load forecaster in accordance with an exemplary embodiment of the present invention, and FIG. 3 illustrates an exemplary diagram of the multi-class in which the SVDDs of the single classes are coupled hierarchically in two phases.

As shown in FIG. 2, there is illustrated a concept diagram for the delivery of information which analyzes and forecasts the electricity use by year, month, week, day and time with respect to each building. In other words, with the prediction of the cooling load and analysis purpose thereof by a manager, it may be possible to deliver information in detail depending on a variety of phases, e.g., year, month, week, day, etc. The phase in level illustrated in FIG. 2 is merely an exemplary diagram and may have a structure of further extended and integrated phase.

FIG. 3 illustrates an SVDD-based hierarchical structure for a cooling load forecast in which the SVDDs of the single classes are coupled in two phases. In the hierarchical structure of the cooling load forecast, a first phase forecasts the cooling load by dividing the time from the morning 9:00 to the afternoon 06:59 into three classes of the morning 09:00˜11:59, the midday 12:00˜15:59 and the morning or evening 16:00˜18:59. A second phase forecasts the use of the cooling load in detail by subdividing the time from 09:00 to 18:59 by a unit of one hour to finely support the cooling load forecast by time.

The training unit 114 generates the multi-class using the single classes, each having a determination boundary surface that represents only the single class when generating the multi-class. For example, the training unit 114 selects the determination boundary surface as ‘one-class SVM’ independently representing a corresponding single class and generates a multi-class SVM on a basis of an SVDD for producing a single class SVM.

The training unit 114 may include a classifier 114a to classifying the respective single classes in the course of the generation of the multi-class SVM.

The classifier 114a generates each of the single classes by defining a sphere which includes the training data for the respective single classes and minimizes its volume, which will be discussed as follows.

Given a k-data set Nₖ of patterns in a d-dimensional input space, Dₖ={xₖⁱεR^{d}|i=1, . . . , Nₖ}, where k=1, . . . , K, the multi-class SVM based on SVDD is defined as the problem of obtaining a hypersphere that maximizes the number of training datasets while minimizing the radius. It is formalized as the following mathematical optimization problem expressed as Equation 6.

$$min {L}_{0} ( {R}_{k}^{2} , {a}_{k} , {ζ}_{k} ) = {R}_{k}^{2} + C {\sum }_{i = 1}^{{N}_{k}} {ζ}_{i}^{k} \\ s . t . {‖ {x}_{i}^{k} - {a}_{k} ‖}^{2} \leq {R}_{k}^{2} + {ζ}_{i}^{k} , {ζ}_{i}^{k} \geq 0 , {∀}_{i} \qquad Eq . 6$$

where aₖ is the center of the sphere that expresses the k-th class, Rₖ² is the square value of the sphere radius, ζᵢ^{k} is a penalty term that denotes the deviation of the i-th training data element xᵢ^{k} from a sphere and C is the trade-off constant.

Lagrange function such as Equation 7 is introduced in order to solve a dual problem on Equation 6.

$$L ( {R}_{k}^{2} , {a}_{k} , {ζ}_{k} , {α}_{k} , {η}_{k} ) = {R}_{k}^{2} + C {\sum }_{i = 1}^{{N}_{k}} {ζ}_{i}^{k} + C {\sum }_{i = 1}^{{N}_{k}} {α}_{i}^{k} [ {( {x}_{i}^{k} - {a}_{k} )}^{T} ( {x}_{i}^{k} - {a}_{k} ) - {R}_{k}^{2} - {ζ}_{i}^{k} ] - {\sum }_{i = 1}^{{N}_{k}} {η}_{i}^{k} {ζ}_{i}^{k}$$

Where,

aᵢ^{k}≧0,nᵢ^{k}≧0,∀ᵢ. Eq. 7

Based on the saddle point condition, Equation 7 must be minimized with respect to Rₖ², a_k and ζᵢ^{k}, and maximized with respect to αₖ and nₖ. The optimal solution of Equation 6 should satisfy the following Equation 8.

$$\frac{\partial L}{\partial {R}_{k}^{2}} = 0 \text{:} {\sum }_{i = 1}^{{N}_{k}} {α}_{i}^{k} = 1 \\ \frac{\partial L}{\partial {ζ}_{k}^{2}} = 0 \text{:} C - {a}_{i}^{k} - x - {η}_{i}^{k} = 0 ∴ {a}_{i}^{k} ∈ [ 0 , C ] , {∀}_{i} \\ \frac{\partial L}{\partial {R}_{k}^{2}} = 0 \text{:} {a}_{k} = {\sum }_{i = 1}^{{N}_{k}} {α}_{i}^{k} {x}_{i}^{k} \qquad Eq . 8$$

By substituting Equation 8 into the Lagrange function L of Equation 7, the double problem can be obtained as in Equation 9.

$$min {\sum }_{i = 1}^{{N}_{k}} {\sum }_{j = 1}^{{N}_{k}} {α}_{i}^{k} {α}_{j}^{k} < {x}_{i}^{k} {x}_{j}^{k} > - {\sum }_{i = 1}^{{N}_{k}} {α}_{i}^{k} < {x}_{i}^{k} {x}_{j}^{k} > \\ s . t . {\sum }_{i = 1}^{{N}_{k}} {α}_{i}^{k} = 1 , {α}_{i}^{k} ∈ [ 0 , C ] , {∀}_{i} \qquad Eq . 9$$

The sphere defined on the input space may represent only a region in an extremely simple form. In order to overcome such a limitation, the sphere may be extended in such a direction to use a sphere defined on a feature space F of a high dimensional that is defined through a kernel function k. Since the respective single classes can express more correctly their boundary in their respective feature spaces, the training of the apparatus may be made by obtaining a solution to a convex QP (Quadratic Problem) corresponding to Equation 10 in consideration of independence of the feature spaces to which the respective classes are mapped.

$$min {\sum }_{i = 1}^{{N}_{k}} {\sum }_{j = 1}^{{N}_{k}} {α}_{i}^{k} {α}_{j}^{k} {k}_{k} ( {x}_{i}^{k} , {x}_{j}^{k} ) - {\sum }_{i = 1}^{{N}_{k}} {α}_{i}^{k} {k}_{k} ( {x}_{i}^{k} , {x}_{j}^{k} ) \\ s . t . {\sum }_{i = 1}^{{N}_{k}} {α}_{i}^{k} = 1 , {α}_{i}^{k} ∈ [ 0 , C ] , {∀}_{i} \qquad Eq . 10$$

Especially, if the Gaussian kernel is used in Equation 10, it comes in k(x,x)=1. Thus, the above problem can be further simplified as below Equation 11.

$$min {\sum }_{i = 1}^{{N}_{k}} {\sum }_{j = 1}^{{N}_{k}} {α}_{i}^{k} {α}_{j}^{k} {k}_{k} ( {x}_{i}^{k} , {x}_{j}^{k} ) \\ s . t . {\sum }_{i = 1}^{{N}_{k}} {α}_{i}^{k} = 1 , {α}_{i}^{k} ∈ [ 0 , C ] , {∀}_{i} \qquad Eq . 11$$

In the course of the application after the completion of the training, the determination function of the respective classes can be defined by following Equation 12.

$${f}_{k} ( x ) = {R}_{k}^{2} - [ 1 - 2 {\sum }_{i = 1}^{{N}_{k}} {α}_{i}^{k} {k}_{k} ( {x}_{i}^{k} , x ) + {\sum }_{i = 1}^{{N}_{k}} {\sum }_{j = 1}^{{N}_{k}} {α}_{i}^{k} {α}_{j}^{k} {k}_{k} ( {x}_{i}^{k} , {x}_{j}^{k} ) ] \geq 0 \qquad Eq . 12$$

Since the output fₓ(x) of a one-class SVM defined in different feature spaces represents the absolute distance between the corresponding data and the decision boundary, determining the pertaining class by comparing absolute distances in different feature spaces is not recommended.

Therefore, an absolute distance fₓ(x) is divided by a radius Rₖ to thereby calculate a relative distance \hat{f}ₓ(x)=fₖ(x)/Rₓ, and a class that has the largest relative distance is determined as a class to which an input data x belongs. That is, the belonging class of the input data x can be determined on a basis of the following Equation 13.

$$Class of x ≡ {argmax}_{k = 1 , … , k {\hat{f}}_{k} ( x )} ≡ argmax k [ \{ {R}_{k}^{2} - ( \begin{matrix}1 - 2 {\sum }_{i = 1}^{{N}_{k}} {α}_{i}^{k} {k}_{k} ( {x}_{i}^{k} , x ) + \\ {\sum }_{i = 1}^{{N}_{k}} {\sum }_{j = 1}^{{N}_{k}} {α}_{i}^{k} {α}_{j}^{k} {k}_{k} ( {x}_{i}^{k} , {x}_{j}^{k} )\end{matrix} ) \} / {R}_{k} ] \qquad Eq . 13$$

The training unit 114 decides the classes to which the respective input data belongs on a basis of Equation 13 using the classifier 114a and generates the multi-class by hierarchically coupling the decided belonging classes.

The training unit 114 also creates the training information for forecasting the cooling load based on the multi-class and then provides the training information to the cooling load forecasting unit 126. That is, the training unit 114 creates the training information every single class and provides the training information to the cooling load forecasting unit 126.

The filtering unit 124 performs a filtering of the low level data on a basis of the optimal attribute set provided from the filtering/attribute selection unit 112 and provides the filtered data to the cooling load forecasting unit 126.

The cooling load forecasting unit 126 forecasts the cooling load on a basis of the training data provided from the filtering unit 124. More specifically, the cooling load forecasting unit 126 forecasts the cooling load for each single class using the filtered data and training information of the corresponding single class.

Although the exemplary embodiment of the present invention has been shown and described as an example of the cooling load, it may be possible to use a variety of energy consumption such as electricity use, water use, and heating energy use, in addition to the cooling load, for the prediction of the energy consumption.

Unlike to provide only the error range between an actual cooling load and a predicted cooling load based on a conventional regression analysis which is a typical statistical method and is actively utilized in the cooling load forecast, the cooling load forecaster 100 in accordance with the embodiment forecasts the cooling load using a structure in which the single classes are hierarchically coupled in two or more levels, thereby enabling to forecast the class-wise cooling load forecast.

Further, the cooling load forecaster 100 in accordance with the embodiment hierarchically defines the levels such as month, week, day, time-of-day to manage the cooling load, thereby enabling the analysis and prediction in accordance with a level of abstraction.

In addition, even though a new level or a new class in the new level is added, the cooling load forecaster 100 in accordance with the embodiment trains only class that has been newly added without having to relearn the entire system again, and, therefore, it is possible to contribute to the progressive expansion and update of a cooling load forecasting system.

While the invention has been shown and described with respect to the exemplary embodiments, the present invention is not limited thereto. It will be understood by those skilled in the art that various changes and modifications may be made without departing from the scope of the invention as defined in the following claims.

What is claimed is:

1. An apparatus for forecasting energy consumption, the apparatus comprising:
a load data collection unit configured to collect low level data from a device that generates energy load data;
a filtering and attribute selection unit configured to eliminate attributes that are duplicated or used below a prefixed average from attributes of the collected low level data to produce an optimal attribute set;
a training unit configured to produce a multi-class in which a plurality of single classes is hierarchically coupled in at least two levels and create training data used for forecasting the energy consumption based on the produced multi-class, wherein each single class includes its optimal attribute set; and
a forecasting unit configured to receive the low level data in real-time from the load data collection unit and calculate the energy consumption to be forecasted on a basis of the received real-time low level data, the multi-class and the training data.

2. The apparatus of claim 1, wherein the filtering and attribute selection unit is configured to calculate a conditional probability using entropies of the attributes, Pearson's correlation coefficients between the attributes and target classes including the attributes and the best search method to produce the optimal attribute set.

3. The apparatus of claim 1, wherein the filtering and attribute selection unit is configured to:
calculate an entropy of an arbitrary attribute contained in the low level data;
calculate a conditional probability between the arbitrary attribute and each of remaining arbitrary attributes;
calculate information gain for each of the arbitrary attribute and the remaining attributes;
calculate conditional probability correlation using the arbitrary attribute and each of remaining arbitrary attributes, the distribution and Pearson's correlation coefficient between the arbitrary attribute and each of remaining arbitrary attributes and target classes including the arbitrary attribute, based on the information gain;
form a plurality of subsets based on the conditional probability correlation; and
calculate merit functions with respect to the plurality of subsets to select a subset whose merit function has the largest value as the optimal attribute set.

4. The apparatus of claim 1, wherein the training unit is configured to produce the multi-class on a basis of an SVDD (Support Vector Data Description) for generating each of the single classes.

5. The apparatus of claim 1, wherein the training unit is configured to produce the multi-class having a determination boundary surface to be independent.

6. The apparatus of claim 1, further comprising a filtering unit configured to filter the real-time low level data using the optimal attribute set,
wherein the forecasting unit is configured to forecast the energy consumption based on the filtered data and the training data.

7. A method for forecasting energy consumption, the method comprising:
collecting low level data from a device that generates energy load data;
eliminating attributes that are duplicated or used below a prefixed average from the attributes of the collected low level data to produce an optimal attribute set;
producing a plurality of single classes, each single class including its optimal attribute set;
producing a multi-class in which the single classes are hierarchically coupled in at least two levels; and
creating training data to forecast the energy consumption based on the produced multi-class.

8. The method of claim 7, wherein said producing the optimal attribute set comprises:
calculating an entropy of an arbitrary attribute contained in the low level data;
calculating a conditional probability between the arbitrary attribute and each of remaining attributes;
calculating information gain for each of the arbitrary attribute and the remaining attributes;
calculating conditional probability correlation using the arbitrary attribute and each of remaining arbitrary attributes, the distribution and Pearson's correlation coefficient between the arbitrary attribute and each of remaining arbitrary attributes and target classes including the arbitrary attribute, based on the information gain;
forming a plurality of subsets based on the conditional probability correlation; and
calculating merit functions with respect to the plurality of subsets to select a subset whose merit function has the largest value as the optimal attribute set.

9. The method of claim 7, wherein said producing a plurality of single classes comprises:
producing a determination boundary surface of each single class so that the plurality of the single classes is independent with one another;
calculating a sphere size including the optimal attribute set; and
producing the plurality of single classes based on the calculate sphere size and the determination border surface.

10. The method of claim 7, wherein said collecting low level data comprises:
filtering the real-time low level data using the optimal attribute set; and
forecasting the energy consumption based on the filtered data and the training data.
